(19) United States
(12) Patent Application Publication
(10) Pub. No.: US 2025/0358837 A1
(43) Pub. Date: Nov. 20, 2025

(54) METHODS, DEVICES, AND SYSTEMS FOR UE CAPABILITY COORDINATION

(71) Applicant: ZTE Corporation, Shenzhen (CN)

(72) Inventors: Wenting LI, Shenzhen (CN); Jing LIU, Shenzhen (CN)

(73) Assignee: ZTE Corporation, Shenzhen (CN)

(21) Appl. No.: 19/286,575

(22) Filed: Jul. 31, 2025

Related U.S. Application Data
(63) Continuation of application No. PCT/CN2023/122121, filed on Sep. 27, 2023.

(51) Int. Cl. H04W 72/51; H04W 72/0457

(52) U.S. Cl. CPC H04W 72/51; H04W 72/0457

(57) ABSTRACT

The present disclosure describes methods, systems, and devices for coordinating user equipment (UE) capability. One method includes receiving, by a master network node from a user equipment (UE), UE aggregated capability information for at least one multi-connection band combination (BC); and sending, by the master network node to a secondary network node, a first message indicating a group of capability resources allowed for the secondary network node, wherein: the group of capability resources comprises at least one of the following: an aggregated bandwidth allowed for the secondary network node, or an aggregated MIMO layer allowed for the secondary network node.

### TECHNICAL FIELD

The present disclosure is directed generally to wireless communications. Particularly, the present disclosure relates to methods, devices, and systems for coordinating user equipment (UE) capability.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

For the 5th Generation (5G) mobile communication technology, a user equipment (UE), for example, a smart phone, may need to report its capability of connecting to one or more network nodes. There are various problems/issues associated with this situation, for example, how the UE report a maximum aggregated bandwidth and/or total multiple input multiple output (MIMO) layer restriction for each supported band combinations to the one or more network nodes. For another example, at the network side with dual connection (DC) or multiple connection (MC) structure, how the one or more network nodes coordination on the maximum aggregated bandwidth and/or aggregated MIMO layer to comply the UE capability.

The present disclosure describes various embodiments for coordinating UE capability, addressing at least one of issues/problems described in the present disclosure, enhancing efficiency and/or improving the performance of the wireless communication.

### SUMMARY

This document relates to methods, systems, and devices for wireless communication, and more specifically, for coordinating user equipment (UE) capability.

In one embodiment, the present disclosure describes a method for wireless communication. The method includes receiving, by a master network node from a user equipment (UE), UE aggregated capability information for at least one multi-connection band combination (BC); sending, by the master network node to a secondary network node, a first message indicating a group of capability resources allowed for the secondary network node, wherein: the group of capability resources comprises at least one of the following: an aggregated bandwidth allowed for the secondary network node, or an aggregated MIMO layer allowed for the secondary network node.

In another embodiment, the present disclosure describes a method for wireless communication. The method includes sending, by a user equipment (UE), UE aggregated capability information for at least one multi-connection band combination (BC) with per BC or per feature set entry granularity; wherein the UE aggregated capability information includes at least one of the following: aggregated capability of MIMO layer; aggregated capability of bandwidth; aggregated capability of cc numbers; or aggregated capability of modulation order.

In another embodiment, the present disclosure describes a method for wireless communication. The method includes receiving, by a secondary network node from a master network node, a first message indicating a group of capability resources allowed for the secondary network node, wherein the master network node receives, from a user equipment (UE), UE aggregated capability information for at least one multi-connection band combination (BC), and determines the group of capability resources allowed for the second network node, and wherein: the group of capability resources comprises at least one of the following: an aggregated bandwidth allowed for the secondary network node, or an aggregated MIMO layer allowed for the secondary network node.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium includes a non-transitory computer-readable medium.

The above and other aspects and their implementations are described in greater detail in the drawings, the descriptions, and the claims.

### BRIEF DESCRIPTION OF THE DRAWINGS

FIG. 1 shows an example of a wireless communication system include more than one network nodes and one or more user equipment.

FIG. 2 shows an example of a network node.

FIG. 3 shows an example of a user equipment.

FIG. 4A shows a user equipment (UE) capability structure of an exemplary embodiment for wireless communication.

FIG. 4B shows an aggregated channel bandwidth/total multiple input multiple output (MIMO) layer per feature set entry of an exemplary embodiment for wireless communication.

FIG. 4C shows an aggregated channel bandwidth/total multiple input multiple output (MIMO) layer per band combination of an exemplary embodiment for wireless communication.

FIG. 4D shows a feature set entry list for a band combination of an exemplary embodiment for wireless communication.

FIG. 4E shows a capability restriction indication between a master node and a secondary node of an exemplary embodiment for wireless communication.

FIG. 5A shows a flow diagram of a method for wireless communication.

FIG. 5B shows a flow diagram of another method for wireless communication.

FIG. 5C shows a flow diagram of another method for wireless communication.

FIG. 6A shows a schematic diagram of an exemplary embodiment for wireless communication.

FIG. 6B shows a schematic diagram of another exemplary embodiment for wireless communication.

FIG. 7A shows a schematic diagram of another exemplary embodiment for wireless communication.

FIG. 7B shows a schematic diagram of another exemplary embodiment for wireless communication.

FIG. 8A shows a schematic diagram of another exemplary embodiment for wireless communication.

FIG. 8B shows a schematic diagram of another exemplary embodiment for wireless communication.

FIG. 9A shows a schematic diagram of another exemplary embodiment for wireless communication.

FIG. 9B shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for coordinating user equipment (UE) capability.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

For the 5th Generation (5G) mobile communication technology, a user equipment (UE), for example, a smart phone, may need to report its capability of connecting to one or more network nodes. There are various problems/issues associated with this situation, for example, how the UE report a maximum aggregated bandwidth and/or total multiple input multiple output (MIMO) layer restriction for each supported band combinations to the one or more network nodes. For another example, at the network side with dual connection (DC) or multiple connection (MC) structure, how the one or more network nodes coordination on the maximum aggregated bandwidth and/or aggregated MIMO layer to comply the UE capability.

The present disclosure describes various embodiments for coordinating UE capability, addressing at least one of issues/problems described in the present disclosure, enhancing efficiency and/or improving the performance of the wireless communication. Under one or more scenarios, a user equipment (UE) may connect to more than one network nodes at the same time. The network nodes, for example, may include one or more radio access network (RAN) node and/or one or more core network (CN) node. In one implementation, the UE may connect with two or more network nodes at the same time, which may be referred as “dual-active state” or “multiple connection state”, which need the UE and/or one or more network nodes to coordinate the multiple connections, so as to provide an efficient system for the one or more scenarios.

One scenario may include that, for a UE having multiple subscriber identity modules (Multi-SIMs) (or multiple universal subscriber identity modules (Multi-USIMs), the UE may connect with the multiple networks at the same time. In another scenario, a UE with a single SIM may connect with the multiple networks at the same time. Another scenario may include, a roaming UE may connect multiple networks for different slices. In another scenario, as an enhancement on the slice, a wireless communication system may need to be enable a roaming UE to access network slices from more than one visited public land mobile networks (VPLMNs) simultaneously, which means the UE may connect to the more than one networks simultaneously, which is similar to the Multi-SIM. In another scenario, the video, imaging and audio for professional applications (VIAPA) may require a method of enabling a UE to receive data services from one network (e.g. non-public network (NPN)) and to receive paging as well as data services from another network (e.g. public land mobile network (PLMN)) simultaneously, which is similar to the Multi-SIM. When the UE configures to connect multiple network at the same time, the UE capability may need to be coordinated.

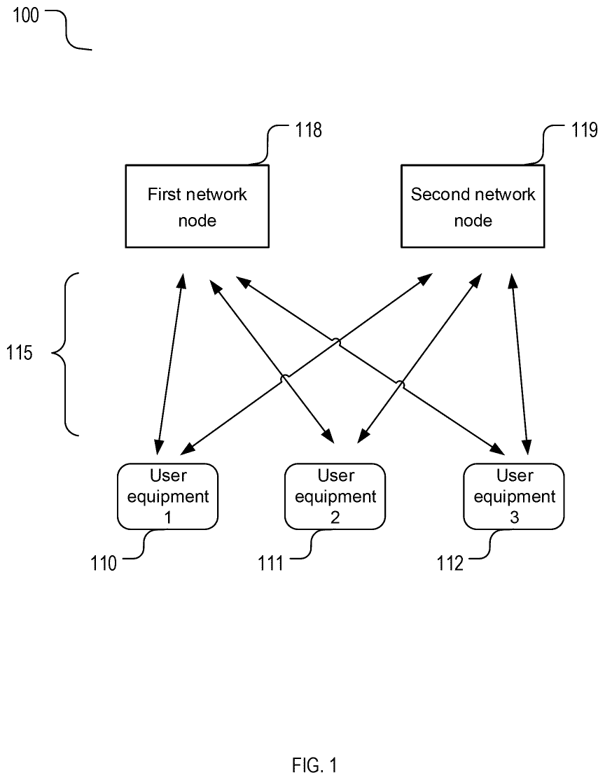

FIG. 1 shows a wireless communication system 100 including more than one network nodes (118 and 119) and one or more user equipment (UE) (110, 111, and 112). In some implementations, the two network nodes (118 and 119) may from two different networks, or may from a same network.

For the 5th generation or newer generation mobile communication technology, a UE 110, for example, a smart phone, may have a single subscriber identity module (SIM) or multiple subscriber identity modules (Multi-SIMs). When the UE has a single SIM, the UE may connect to one network node 118, for example, a radio access network (RAN) node and/or a core network (CN) node, or may connect to more than one network nodes (118 and 119), for example, two RAN nodes and/or two CN nodes. When the UE has Multi-SIMs, the UE may connect to more than one network nodes (118 and 119), for example, two RAN nodes, two CN nodes, and/or one RAN node and one CN node.

The wireless network node (118 and 119) may include a network base station, which may be a nodeB (NB, e.g., eNB, or gNB) in a mobile telecommunications context. Each of the UE (110, 111, and/or 112) may wirelessly communicate with the wireless network node (118 and/or 119) via one or more radio channels 115. For example, the first UE 110 may wirelessly communicate with the first network node 118 via a channel including a plurality of radio channels during a certain period of time; during another period of time or simultaneously at the same time, the first UE 110 may wirelessly communicate with the second network node 119 via a channel including a plurality of radio channels.

The present disclosure describes various embodiments for user equipment (UE) capability coordination in dual-connection (DC) for one, some, or all of the scenarios as described in the present disclosure. The present disclosure describes methods, systems, and storage medium of how the UE coordinates temporary UE capability restriction (e.g., UE capability restriction information) to one or more network (or network node), and/or how one or more network node coordinate temporary UE capability restriction (e.g., UE capability restriction information) to other network nodes and/or to the UE.

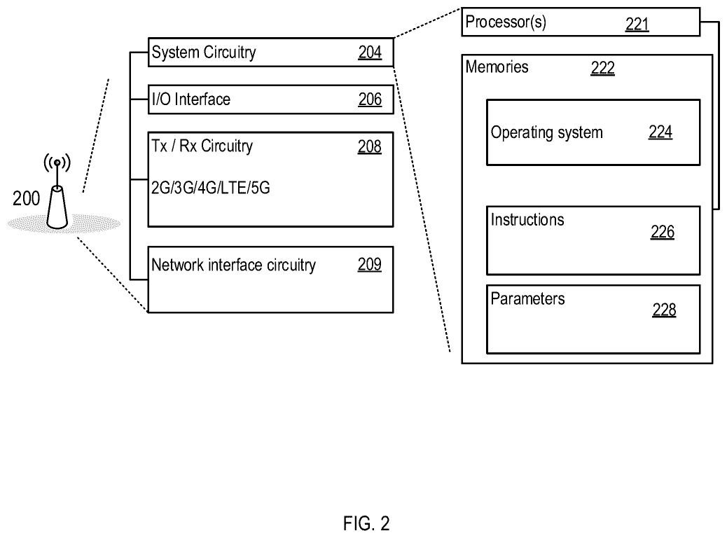

FIG. 2 shows an example of electronic device 200 to implement a network node or network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

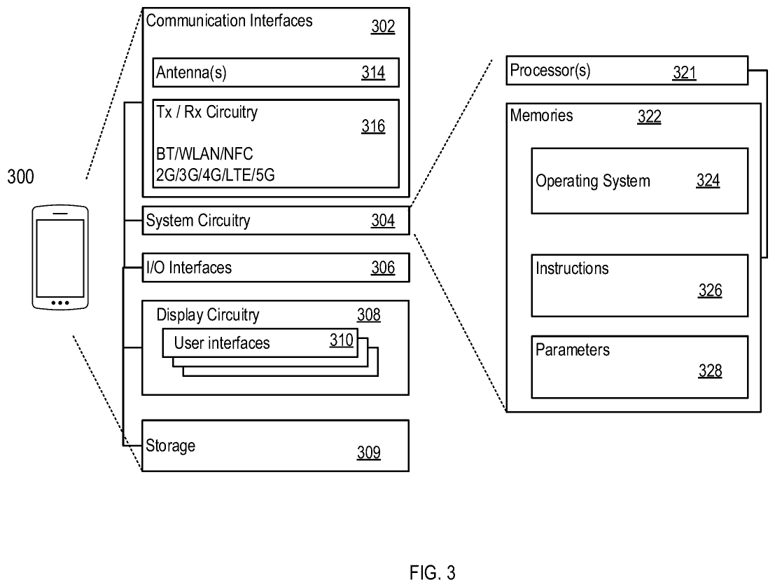

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310.

The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, and/or further developed standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

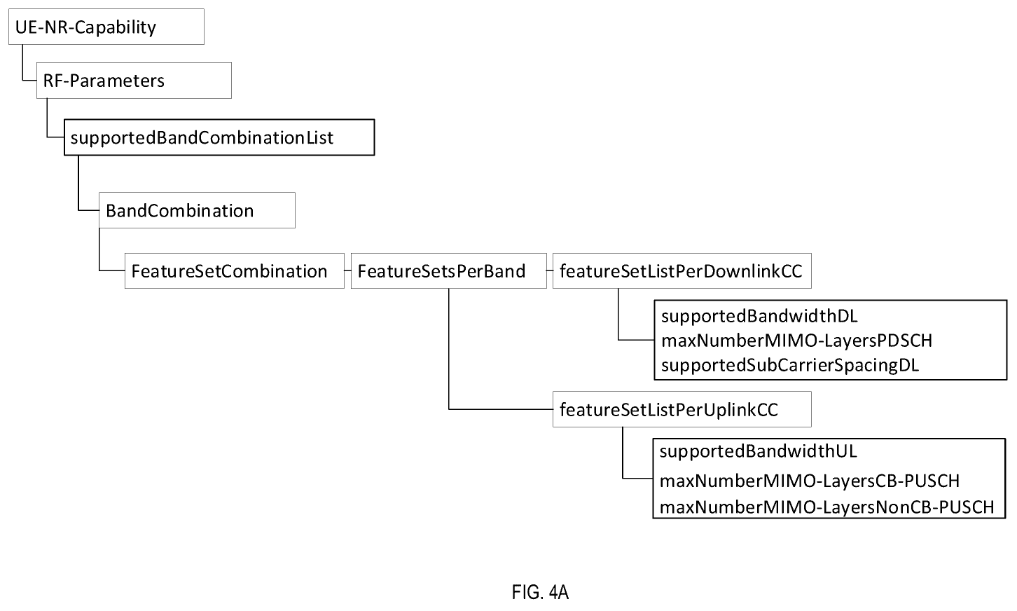

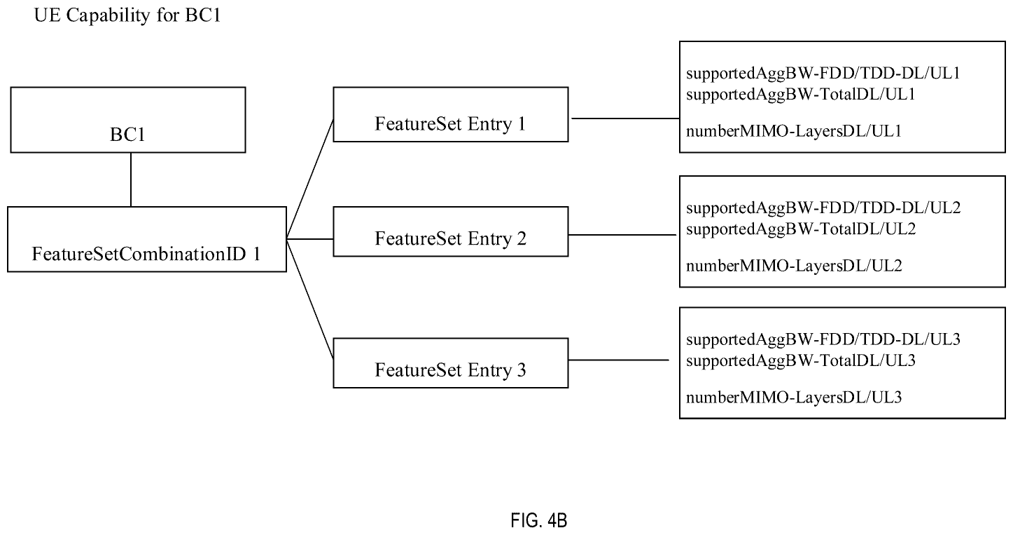

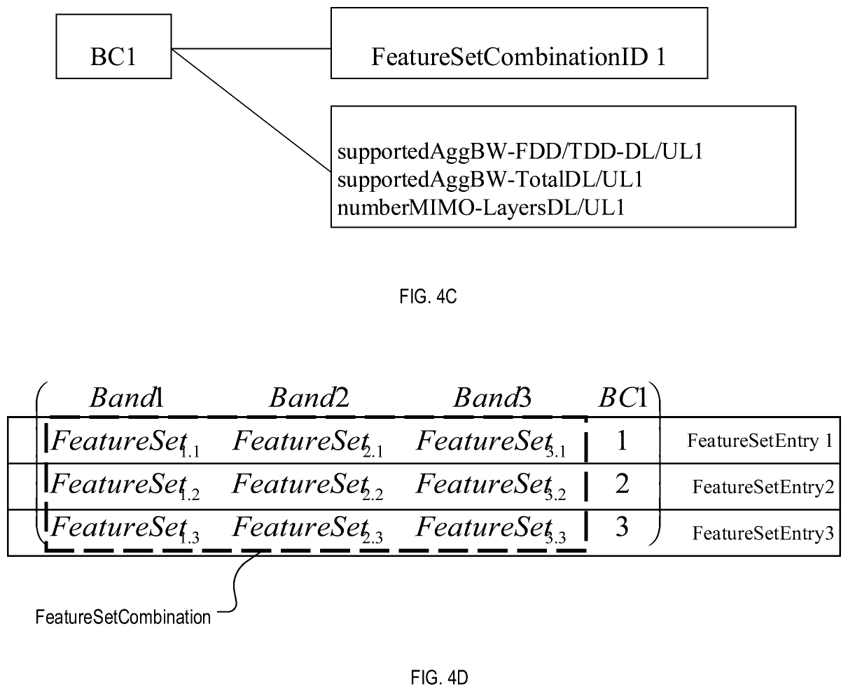

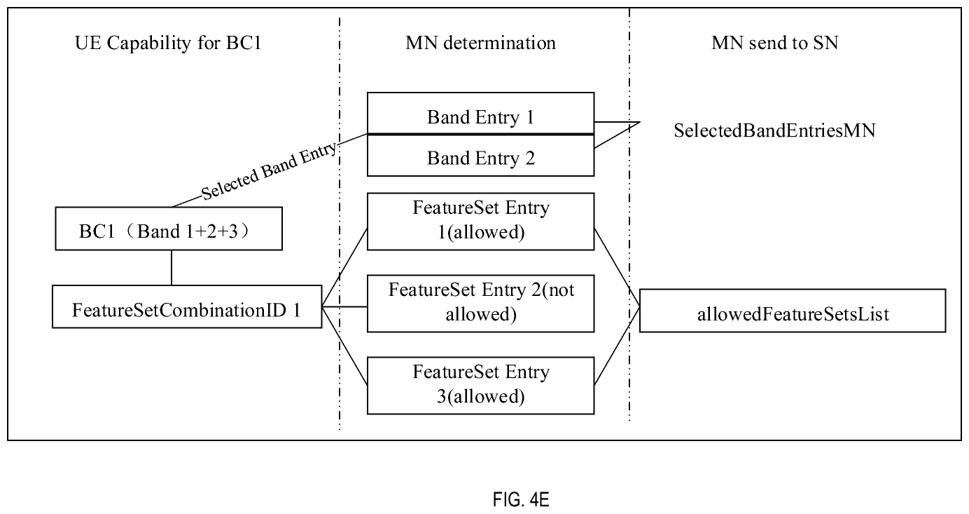

In some implementations, to support the dual or multiple connection, a UE may report the supported band combinations (BCs) to the network, in which the baseband/RF capabilities may be also indicated by a featureset combination indication. A featureset combination may include multiple featureset entries. Each featureset entry includes a featureset for each band in this band combination. A featureset can include capabilities for one or more carriers. Referring to FIG. 4A for the downlink as a non-limiting example, in the featureSetDownkink per carrier component (CC), it would include the supportedbandwidth/Maximum MIMO layer and some other parameters.

In some implementations, to reduce the signaling overhead, especially the feature sets reporting, the UE may report the aggregated channel bandwidth/aggregated MIMO layer per FeatureSetEntry or per BC or per frequency range per BC for the multi-connection BC. For non-limiting example, FIG. 4B shows an implementation of aggregated channel bandwidth/Aggregated MIMO layer per FeatureSetEntry; and FIG. 4C shows an implementation of aggregated channel bandwidth/Aggregated MIMO layer per BC. In some implementations, for the aggregated bandwidth, the UE may report the aggregated bandwidth for all of the frequency division duplex (FDD) bands, all of the time division duplex (TDD) bands, and/or all of both TDD and FDD bands.

In some implementations, taking the aggregated bandwidth per BC as an example, the UE indicates, to the network, maximum aggregated bandwidth with 160 Mhz for a BC with 2 TDD bands, wherein for each band there is only one carrier. Based on such, the network may know that the UE can support the below cases in Table 1 for the different bandwidth combination. As shown in this example with Table 1, the UE may only need to report the parent case with the aggregated bandwidth, rather than the 4 child cases without the aggregated bandwidth, which can substantially save the signaling (up to 75% saving of signaling), enhancing efficiency and improving performance of wireless communication.

TABLE 1
A non-limiting example of aggregated bandwidth

| Downlink --Parent Case | Child-cases | Band 1(cc1) | Band 2(cc2) |
|---|---|---|---|
| The UE report | Sub-case 1: | 100 | 60 |
| supportedBandwidthDL = | Sub-case 2: | 80 | 80 |
| 100M for each CC and | Sub-case 3: | 70 | 90 |
| Maximum aggregated DL | Sub-case 4: | 60 | 100 |
| TDD bandwidth = 160 MHz | | | |

In some implementations, the aggregated bandwidth/aggregated MIMO layer for NR-DC BC may be defined per frequency range per BC, for example, the UE reports the aggregated bandwidth/Aggregated MIMO layer per frequency range 1 per BC for the NR-DC band combination, or per frequency range 1 per FeatureSetEntry, which means that the aggregated bandwidth/Aggregated MIMO layer is applied as restriction across the bands belong to the frequency range 1. For example, the UE supports a BC with 3 bands, for example three bands of [n41, n78, n261], then the aggregated bandwidth/aggregated MIMO layer may be applied for the n41+n78 whatever the cell group is. When the cell group is [n41, n78] at the MN side and [n261] at the SN side, the aggregated bandwidth may be applied to the MN side; and/or when the cell group is [n41] at the MN side and [n78, n261] at the SN side, the aggregated bandwidth may be applied to sum of the n41 bandwidth of the MN and the n78 bandwidth of the SN.

In some implementations for the dual connection with a master node (MN) and a secondary node (SN), the UE may report supported band combinations to the MN, then the MN may coordinate with the SN about the capability. For a non-limiting example with certain MN-SN coordination for the capability coordination, the MN may indicate the available band combination information to the SN as shown in Table 2.

TABLE 2
A non-limiting example of MN-SN coordination

MN->SN:

| | |
|---|---|
| BandCombinationInfoList ::= | SEQUENCE (SIZE (1..maxBandComb)) OF BandCombinationInfo |
| BandCombinationInfo ::= | SEQUENCE { |
| bandCombinationIndex | , |
| allowedFeatureSetsList | SEQUENCE (SIZE (1..maxFeatureSetsPerBand)) OF |

FeatureSetEntryIndex
}

| | |
|---|---|
| selectedBandEntriesMNList | SEQUENCE (SIZE (1..maxBandComb)) OF |

SelectedBandEntriesMN

| | |
|---|---|
| SelectedBandEntriesMN ::= | SEQUENCE (SIZE (1..maxSimultaneousBands)) OF |

BandEntryIndex

In some implementations, the MN may indicate the SN about the available BC list, selected band entries and featureSet entries for each BC, wherein the FeatureSetEntryIndex may be used to indicate the supported Feature Set Entry. For a non-limiting example referring to FIG. 4D, the BC1 includes 3 bands (e.g., Band 1, Band 2, and Band 3), and also 3 feature set entries (e.g., FeatureSetEntry 1, FeatureSetEntry 2, and FeatureSetEntry 3) in the corresponding FeatureSetCombination. For a non-limiting example, for the BC1, when only the FeatureSetEntry 1 and FeatureSetEntry 3 can be used by the SN, the MN may set the allowedFeatureSetsList=[0][2], representing FeatureSetEntry 1 and FeatureSetEntry 3, for the BC1. For the BC1, when the MN selects band 1 and band 2, the MN would set the SelectedBandEntriesMN=[0][1], representing band 1 and band 2, for the BC1.

In some implementations of capability restriction indication between the MN and SN for each available BC list, referring to FIG. 4E, when the MN determines that it may work on band 1+band 2 with FeatureSet Entry 1/3, the MN may indicate the information, as shown in FIG. 4E, to the SN for the BC1; and then, the SN may only select Band 3 with FeatureSet Entry 1/3. In some implementations, the indicated information may include allowedFeatureSetsList=[0][2] and/or SelectedBandEntriesMN=[0][1].

Some implementations with the MN-SN coordinate method as described above, the SN may not know the aggregated bandwidth the SN side can be used for that the MN doesn't indicate the aggregated bandwidth occupied at the MN side. The similar thing may also happen for the MIMO layer.

The present disclosure describes various embodiments for coordinating UE capability, addressing at least one of issues/problems described in the present disclosure, enhancing efficiency and/or improving the performance of the wireless communication.

In the present disclosure, the word “aggregated” may be replaced by “total” in multiple terms to express the same meaning, or vice versa. For non-limiting examples, aggregated capability may be same as total capability, aggregated bandwidth may be same as total bandwidth, and/or aggregated MIMO layer may be same as total MIMO layer.

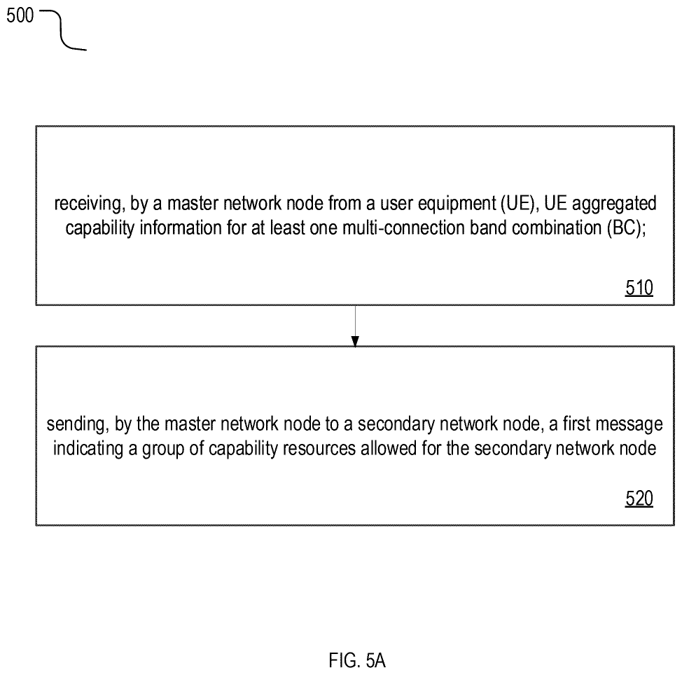

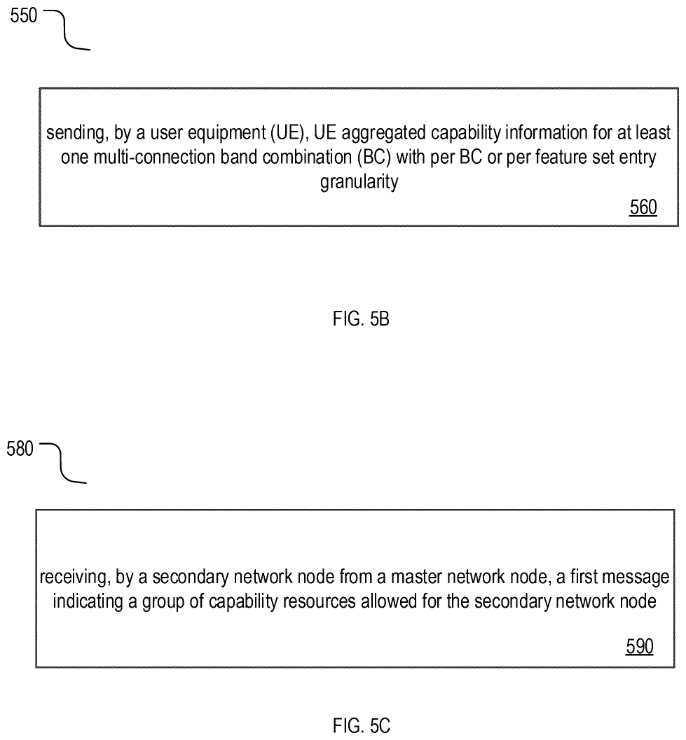

Referring to FIG. 5A, the present disclosure describes embodiments of a method 500 for wireless communication. The method 500 may include a portion or all of the following: step 510, receiving, by a master network node from a user equipment (UE), UE aggregated capability information for at least one multi-connection band combination (BC); step 520, sending, by the master network node to a secondary network node, a first message indicating a group of capability resources allowed for the secondary network node. In some implementations, the group of capability resources comprises at least one of the following: an aggregated bandwidth allowed for the secondary network node, and/or an aggregated MIMO layer allowed for the secondary network node.

Referring to FIG. 5B, the present disclosure describes embodiments of a method 550 for wireless communication. The method 550 may include step 560, sending, by a user equipment (UE), UE aggregated capability information for at least one multi-connection band combination (BC) with per BC or per frequency range per BC or per feature set entry granularity. In some implementations, the UE aggregated capability information includes at least one of the following: aggregated capability of MIMO layer; aggregated capability of bandwidth; aggregated capability of cc numbers; and/or aggregated capability of modulation order. Here, “aggregated capability” may be referred as “total capability”.

Referring to FIG. 5C, the present disclosure describes embodiments of a method 580 for wireless communication. The method 580 may include step 590, receiving, by a secondary network node from a master network node, a first message indicating a group of capability resources allowed for the secondary network node. In some implementations, the master network node receives, from a user equipment (UE), UE aggregated capability information for at least one multi-connection band combination (BC), and determines the first group of capability resources allowed for the second network node. In some implementations, the group of capability resources comprises at least one of the following: an aggregated bandwidth allowed for the secondary network node, and/or an aggregated MIMO layer allowed for the secondary network node.

In some implementations, in additional to a portion or a combination of implementations or embodiments described in the present disclosure, the UE aggregated capability information includes at least one of the following with per BC or per frequency range per BC or per feature set entry granularity: aggregated capability of MIMO layer; aggregated capability of bandwidth; aggregated capability of cc numbers; and/or aggregated capability of modulation order.

In some implementations, in additional to a portion or a combination of implementations or embodiments described in the present disclosure, the first message comprises at least one of the following: the aggregated bandwidth allowed for the master network node, and/or the aggregated multiple input multiple output (MIMO) layer allowed for the master network node.

In some implementations, in additional to a portion or a combination of implementations or embodiments described in the present disclosure, the secondary network node determines the group of capability resources based on the first message and the UE aggregated capability information.

In some implementations, in additional to a portion or a combination of implementations or embodiments described in the present disclosure, the first message comprises at least one of the following: an aggregated bandwidth allowed for the secondary network node, and/or an aggregated MIMO layer allowed for the secondary network node.

In some implementations, in additional to a portion or a combination of implementations or embodiments described in the present disclosure, the aggregated bandwidth has a granularity of per BC or per frequency range per BC; and/or the aggregated MIMO layer has a granularity of per BC or per frequency range per BC.

In some implementations, in additional to a portion or a combination of implementations or embodiments described in the present disclosure, the granularity of per BC comprises one of the following: per frequency division duplex (FDD) per BC, per time division duplex (TDD) per BC, or per combined FDD-TDD per BC.

In some implementations, in additional to a portion or a combination of implementations or embodiments described in the present disclosure, the aggregated bandwidth has a granularity of per feature set entry or per frequency range per feature set entry; and/or the aggregated MIMO layer has a granularity of per feature set entry or per frequency range per feature set entry.

In some implementations, in additional to a portion or a combination of implementations or embodiments described in the present disclosure, the granularity of per feature set entry comprises one of the following: per frequency division duplex (FDD) per feature set entry, per time division duplex (TDD) per feature set entry, or per combined FDD-TDD per feature set entry.

In some implementations, in additional to a portion or a combination of implementations or embodiments described in the present disclosure, the UE aggregated capability information comprises a plurality of per BC restrictions; the first message indicates per BC restrictions information to the secondary network node; and/or the secondary network node selects a BC restriction based on the first message and indicates the selected BC restriction to the master network node.

In some implementations, in additional to a portion or a combination of implementations or embodiments described in the present disclosure, a granularity of the aggregated bandwidth comprises at least one of the following: per UE, per band, or per frequency range.

In some implementations, in additional to a portion or a combination of implementations or embodiments described in the present disclosure, the group of capability resources comprises at least one of the following: a maximum total carrier component (CC) number allowed for the master network node, and/or a maximum total modulation order allowed for the master network node; a maximum total carrier component (CC) number allowed for the secondary network node, and/or a maximum total modulation order allowed for the secondary network node.

In some implementations, in additional to a portion or a combination of implementations or embodiments described in the present disclosure, the aggregated bandwidth has a different granularity from that of the aggregated MIMO layer.

The present disclosure describes various exemplary embodiments for coordinating user equipment (UE) capability, which serve as examples and do not impose any limitation on the present disclosure.

### Embodiment Set I

The present disclosure describes various embodiments for addressing the issue/problem of how the SN know the aggregated bandwidth/aggregated MIMO layer restriction at the SN side. The issue/problem may include, with the current MN-SN coordinate method, the SN doesn't know the aggregated bandwidth/MIMO layer restriction at the SN side; and/or the SN may only know the aggregated bandwidth for the whole band combination (include both MN side band entries and SN side band entries).

The present disclosure describes various embodiments, wherein the MN indicates the allowed aggregated bandwidth/aggregated MIMO layer at the SN side to the SN via at least one of the following options: Option 1: the MN sends the following information to the SN (i.e., MN->SN): aggregated bandwidth/aggregated MIMO layer at the MN side, and then, the SN determines the allowed aggregated bandwidth/aggregated MIMO layer at the SN side; and/or Option 2: the MN sends the following information to the SN (i.e., MN->SN): allowed aggregated bandwidth/aggregated MIMO layer at the SN side.

In some implementations, each of the above options may be per BC, for example, per FDD per BC, per TDD per BC, and/or per FDD+TDD per BC.

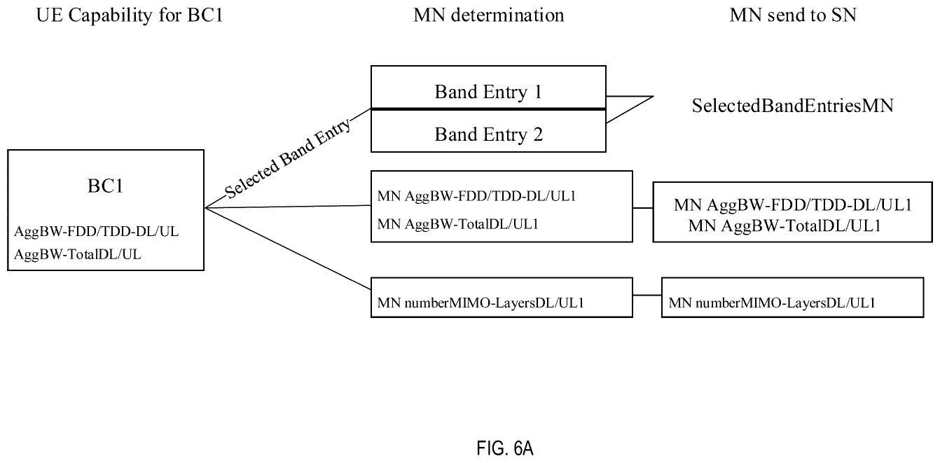

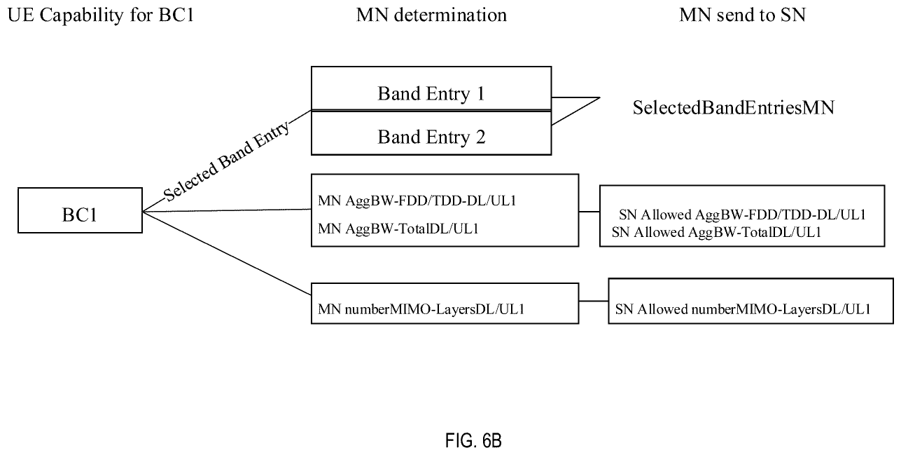

For one non-limiting example with respect to Option 1 with per BC granularity is shown in FIG. 6A. The UE may report supported AggBW-FDD/TDD-DL/UL1 and/or AggBW-TotalDL/UL1 per BC for the multi-connection band combination, and then the MN determines the aggregated bandwidth/aggregated MIMO layer at the MN side and sends the MN aggregated bandwidth/aggregated MIMO layer to the SN. The SN further determines the allowed aggregated bandwidth/aggregated MIMO layer at the SN side. When the UE reports the supported AggBW-TDD-DL=160 Mhz for the BC1 and MN would use 100 M, the MN may indicate MN AggBW-TDD-DL=100 M. Furthermore, the SN may get the UE supported AggBW-TDD-DL from the UE capability reporting, and thus, the SN may know the allowed AggBW-TDD-DL at the SN side is 60 M (i.e, based on 160 M-60 M).

For another non-limiting example with respect to Option 2 with per BC granularity is shown in FIG. 6B, wherein the SN allowed aggregated bandwidth/aggregated MIMO layer is equal to UE supported aggregated bandwidth/aggregated MIMO layer minus MN aggregated bandwidth/aggregated MIMO layer. In this example, the UE reports supported AggBW-FDD/TDD-DL/UL1 and/or AggBW-TotalDL/UL1 per Featureset, and then the MN determines the allowed aggregated bandwidth/aggregated MIMO layer at the SN side and send it to the SN. When the UE reports the supported AggBW-TDD-DL=160 Mhz for the BC1 and MN would use 100 M, the MN may indicate to the SN that the allowed AggBW-TDD-DL=60 M.

In various embodiments, the granularity of each option may be per FeatureSetEntry per BC, e.g., per FDD per FeatureSetEntry, per TDD per FeatureSetEntry, and/or per FDD+TDD per FeatureSetEntry.

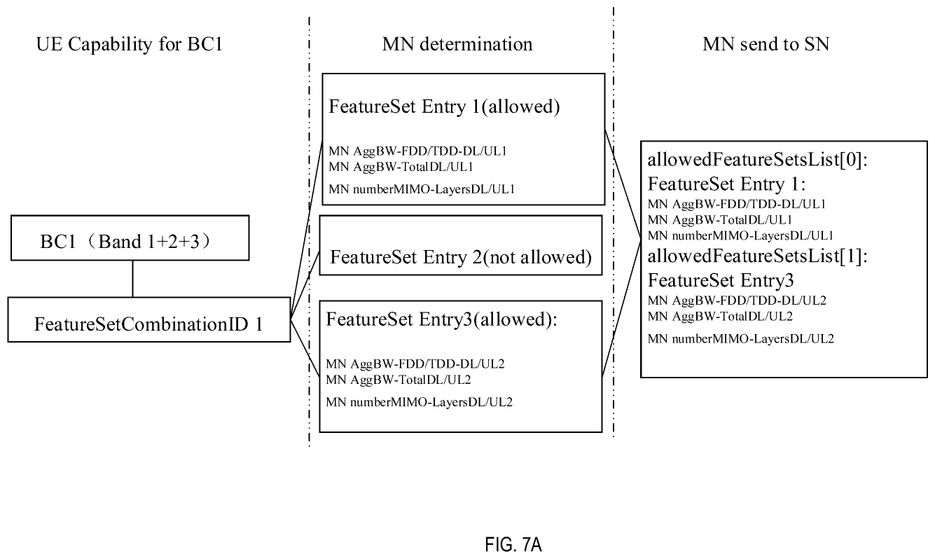

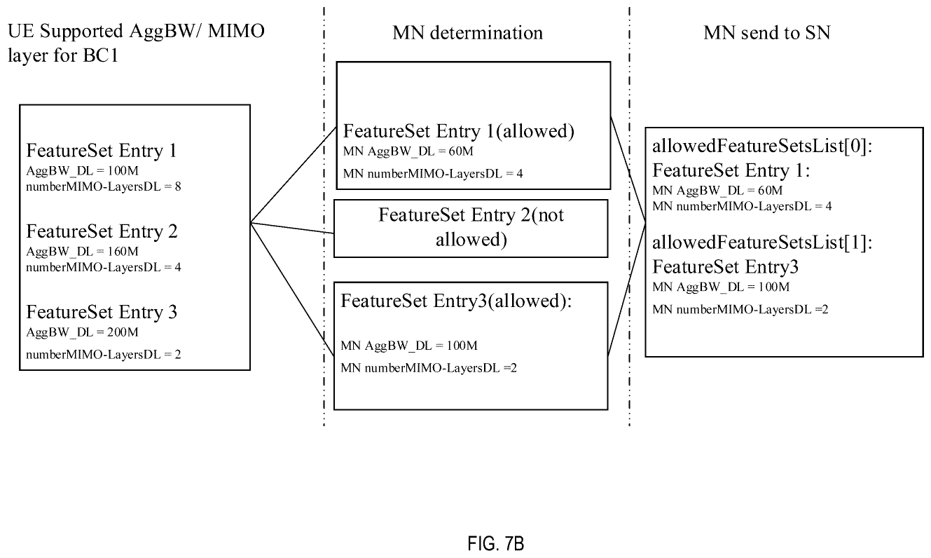

For a non-limiting example with respect to Option 1 with per FeatureSetEntry granularity is shown in FIG. 7A. The UE reports supported AggBW-FDD/TDD-DL/UL1 and/or AggBW-TotalDL/UL1 per FeatureSetEntry per BC, and then the MN determines the aggregated bandwidth/aggregated MIMO layer for the allowed feature set Entries at the MN side and sends the MN aggregated bandwidth/aggregated MIMO layer per feature set Entries to the SN. The SN further determines the allowed aggregated bandwidth/aggregated MIMO layer per feature set Entries at the SN side.

For another non-limiting example with respect to Option 1 with per FeatureSetEntry granularity is shown in FIG. 7B. When the UE reports the supported AggBW-TDD-DL=100 MHz/aggregated MIMO layer=8 for the Featureset Entry 1 and AggBW-TDD-DL=200 MHz/aggregated MIMO layer=2 for the Featureset Entry 3. At the MN side, the MN only selects the feature set Entry 1 and 3 as allowed, and MN may use MN AggBW-TDD-DL=60 Mhz/MN aggregated MIMO layer=4 for the Featureset Entry 1, MN AggBW-TDD-DL=100 Mhz/aggregated MIMO layer=2 for the Featureset Entry 3, then the MN may indicate this information to the SN. The SN may further determine the SN allowed AggBW-TDD-DL/aggregated MIMO layer at the SN side for each feature set Entry. In FIG. 7B, the AggBW_DL may be AggBW-TDD-DL or AggBW-FDD-DL or AggBW-Total-DL. The above examples use downlink as examples, and furthermore, examples for uplink may be similar and analogous to the downlink examples.

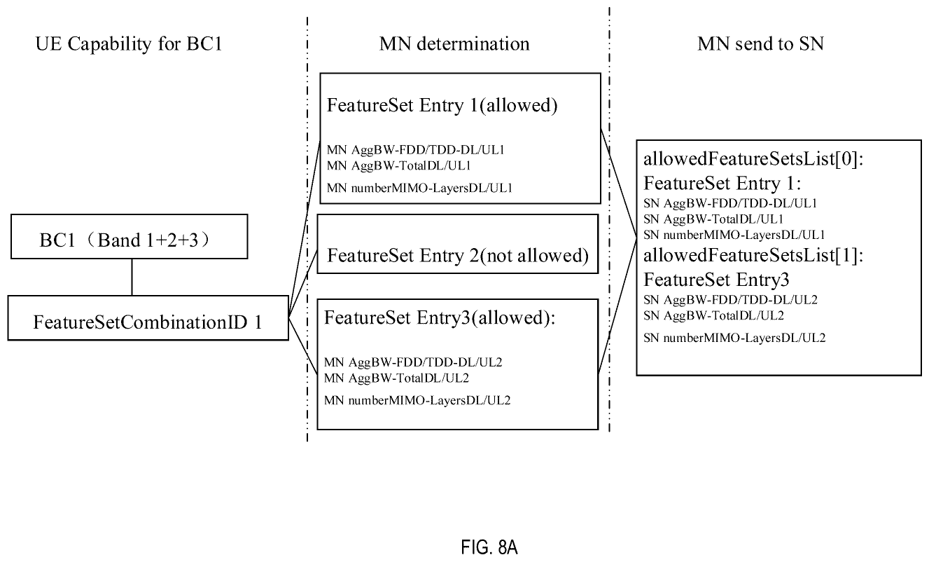

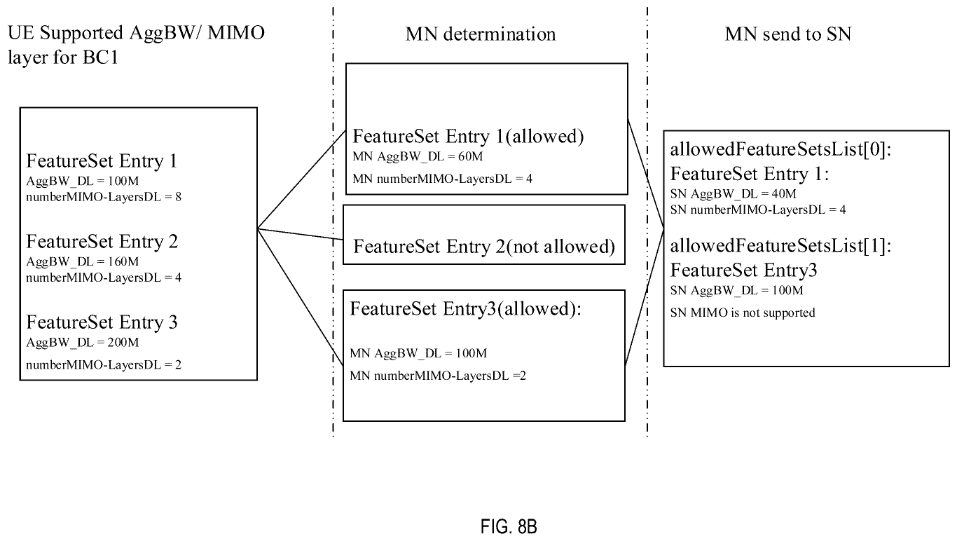

For non-limiting examples with respect to Option 2 with per FeatureSetEntry granularity is shown in FIG. 8A and FIG. 8B. The UE reports the supported AggBW-TDD-DL=100 MHz/aggregated MIMO layer=8 for the Featureset Entry 1 and AggBW-TDD-DL=200 MHz/aggregated MIMO layer=2 for the Featureset Entry 3. At the MN side, the MN only selects the feature set Entry 1 and 3 as allowed, and MN may use MN AggBW-TDD-DL=60 Mhz/MN aggregated MIMO layer=4 for the Featureset Entry 1, MN AggBW-TDD-D=100 Mhz/aggregated MIMO layer=2 for the Featureset Entry 3, and then, the MN may indicate allowed SN AggBW-TDD-DL=40 Mhz/MN aggregated MIMO layer=4 for the Featureset Entry 1, SN AggBW-TDD-DL=100 Mh without supporting MIMO for the Featureset Entry 3. In FIG. 8B, the AggBW_DL may be AggBW-TDD-DL or AggBW-FDD-DL or AggBW-Total-DL. The above examples use downlink as examples, and furthermore, examples for uplink may be similar and analogous to the downlink examples.

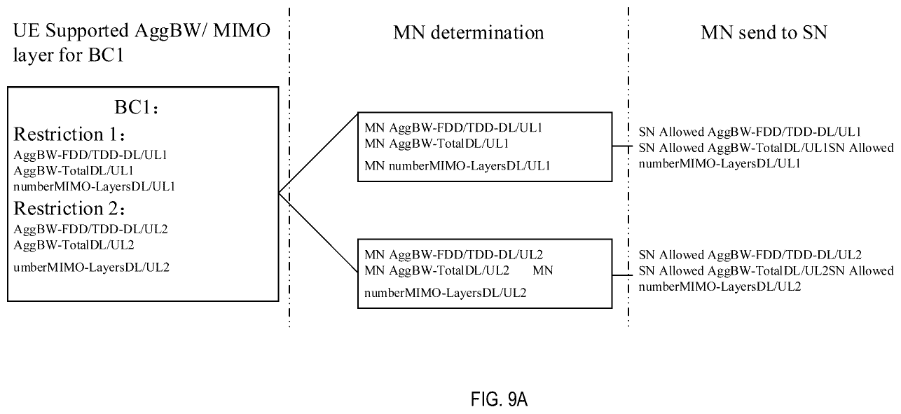

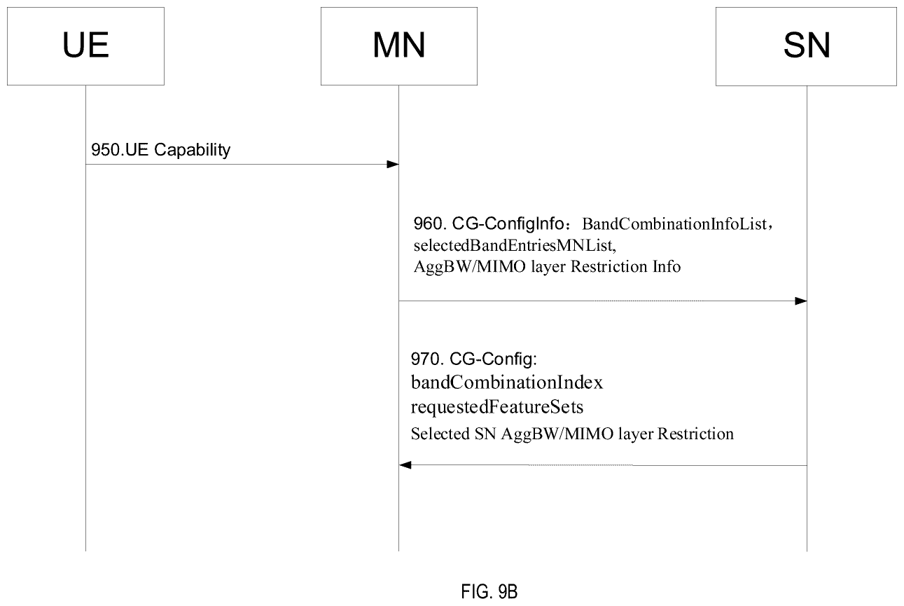

In various embodiments, for both per BC and per Feature set Entry solution, the UE may indicate multiple restriction groups, and/or then, the MN may also indicate multiple restriction to the SN. A non-limiting example per BC is shown in FIG. 9A, wherein the SN may also need to feedback which restriction is adopted at the SN side. An exemplary procedure of a MN-SN coordination procedure is shown in FIG. 9B. In Step 950, the UE sends UE capability information to the MN. In Step 960: when getting the UE capability, the MN may indicate the allowed band combination list together with the allowed featureset Entries for each allowed BC, meanwhile the MN may also indicate the aggregated BW/MIMO layer restriction info to the SN as described above. In step 970: when the SN selects one of the restrictions, the SN may indicate the selected restriction to the MN.

The above examples use per BC as examples, and furthermore, examples for per FeatureSetEntry may be similar and analogous to the above examples (with per FeatureSetEntry).

In various embodiments, the granularity may be per UE, or per band, and/or per frequency range, wherein per UE means allow of the allowed BC adopt the same aggregated bandwidth/aggregated MIMO layer restriction, per UE also includes per FDD/Per TDD/Per FDD+TDD case.

In various embodiments, besides the aggregated bandwidth/aggregated MIMO layer, for the other parameters that the UE report maximum aggregated/Total value, the same logical can be adopted, for non-limiting examples, maximum total CC numbers/Modulation orders and etc.

In various embodiments, the different parameters may have different granularity, e.g. the aggregated bandwidth restriction is per FeatureSetEntry while the aggregated MIMO layer restriction is per BC.

### Embodiment Set II

The present disclosure describes various embodiments for addressing the issue/problem of when the SN cannot accept the restriction indicated by the MN, how the SN feedbacks to the MN. The issue/problem may include, the MN may indicate the SN allowed band combination information together with the allowed aggregated bandwidth/aggregated MIMO layer. However when the SN need to request the band combinations or the featureset entries outside of the restriction (e.g. considering the mobility, the SN can't work on the allowed band combinations indicated by the MN or the SN can work on the allowed band combinations but can't comply the allowed aggregated bandwidth/aggregated MIMO layer restriction on the selected BC), how does the SN feedback?

The present disclosure describes various embodiments for addressing the above issue/problem, wherein the SN may indicate its suggestions on its selected BC to the MN, e.g. indicating the allowed aggregated bandwidth/aggregated MIMO layer at the MN side to the MN via at least one of the following options: Option 1: SN->MN: Aggregated bandwidth/aggregated MIMO layer at the SN side, and then the MN determines the allowed aggregated bandwidth/aggregated MIMO layer at the MN side; and/or Option 2: SN->MN: allowed aggregated bandwidth/aggregated MIMO layer at the MN side.

In some implementations for the SN feedback, normally, the SN may only indicate one BC with one FeaturesetEntry.

In some implementations, the granularity of each option can be per BC, e.g. per FDD per BC, per TDD per BC, and/or per FDD+TDD per BC.

In some implementations, the granularity of each option can be per FeatureSetEntry per BC, e.g. per FDD per FeatureSetEntry, per TDD per FeatureSetEntry, and/or per FDD+TDD per FeatureSetEntry.

In various embodiments, the granularity can also be or per UE, or per band, and/or per frequency range, wherein per UE means allow of the allowed BC adopt the same aggregated bandwidth/aggregated MIMO layer restriction, per UE also includes per FDD/Per TDD/Per FDD+TDD case.

In various embodiments, besides the aggregated bandwidth/aggregated MIMO layer, for the other parameters that the UE report maximum aggregated/Total value, the same logical can be adopted, for non-limiting examples, maximum total CC numbers/Modulation orders and etc.

In various embodiments, the different parameters may have different granularity, e.g. the aggregated bandwidth restriction is per FeatureSetEntry while the aggregated MIMO layer restriction is per BC.

The present disclosure describes methods, apparatus, and computer-readable medium for wireless communication. The present disclosure addressed the issues with coordinating user equipment (UE) capability. The methods, devices, and computer-readable medium described in the present disclosure may facilitate the performance of wireless communication, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments, for non-limiting examples, a portion from one or more embodiment may be combined with another portion of other embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
receiving, by a master network node from a user equipment (UE), UE aggregated capability information for at least one multi-connection band combination (BC); and
sending, by the master network node to a secondary network node, a first message indicating a group of capability resources allowed for the secondary network node,
wherein:
the group of capability resources comprises an aggregated bandwidth allowed for the secondary network node.

2. The method according to claim 1, wherein:
the UE aggregated capability information includes aggregated capability of bandwidth per BC.

3. A method for wireless communication, comprising:
sending, by a user equipment (UE), UE aggregated capability information for at least one multi-connection band combination (BC) with per BC granularity;
wherein the UE aggregated capability information includes
aggregated capability of bandwidth.

4. A method for wireless communication, comprising:
receiving, by a secondary network node from a master network node, a first message indicating a group of capability resources allowed for the secondary network node,
wherein: the group of capability resources comprises
an aggregated bandwidth allowed for the secondary network node.

5. (canceled)

6. (canceled)

7. The method according to claim 1 , wherein:
the aggregated bandwidth has a granularity of per BC.

8. The method according to claim 7, wherein:
the granularity of per BC comprises one of the following: per frequency division duplex (FDD) per BC, per time division duplex (TDD) per BC, or per combined FDD-TDD per BC.

9. (canceled)

10. (canceled)

11. The method according to claim 1, wherein:
the UE aggregated capability information comprises a plurality of per BC restrictions;
the first message indicates BC restriction information to the secondary network node; and
the method further comprises:
receiving, by the master network node, an indication for a BC restriction that is selected by the secondary network node based on the first message.

12-16. (canceled)

17. The method according to claim 1, further comprising:
receiving, by the master network node, an indication for indicating a BC restriction and the aggregated bandwidth at the secondary network node, wherein the BC restriction is selected by the secondary network node based on the first message.

18. The method according to claim 17, wherein:
the aggregated bandwidth has a granularity per BC comprising at least one of the following: per frequency division duplex (FDD) per BC, per time division duplex (TDD) per BC, or per combined FDD-TDD per BC.

19. The method according to claim 3, wherein:
the aggregated capability of bandwidth has a granularity of per BC.

20. The method according to claim 19, wherein:
the granularity of per BC comprises one of the following: per frequency division duplex (FDD) per BC, per time division duplex (TDD) per BC, or per combined FDD-TDD per BC.

21. The method according to claim 4, wherein:
the aggregated bandwidth has a granularity of per BC.

22. The method according to claim 21, wherein:
the granularity of per BC comprises one of the following: per frequency division duplex (FDD) per BC, per time division duplex (TDD) per BC, or per combined FDD-TDD per BC.

23. The method according to claim 4, further comprising:
receiving, by the secondary network node, the first message for indicating BS restriction information; and
selecting, by the secondary network node, a BC restriction based on the first message and indicating the selected BC restriction to the master network node.

24. The method according to claim 4, further comprising
selecting, by the secondary network node, a BC restriction based on the first message; and
sending, by the secondary network node, an indication to the master network node, the indication indicating the selected BC restriction and the aggregated bandwidth at the secondary network node.

25. The method according to claim 24, wherein:
the aggregated bandwidth has a granularity per BC comprising at least one of the following: per frequency division duplex (FDD) per BC, per time division duplex (TDD) per BC, or per combined FDD-TDD per BC.

26. A user equipment (UE) comprising:
a memory storing instructions; and
at least one processor in communication with the memory, wherein, when the at least one processor executes the instructions, the at least one processor is configured to cause the UE to perform:
sending UE aggregated capability information for at least one multi-connection band combination (BC) with per BC granularity;
wherein the UE aggregated capability information includes aggregated capability of bandwidth.

27. The UE according to claim 26, wherein:
the aggregated capability of bandwidth has a granularity of per BC.

28. The UE according to claim 27, wherein:
the granularity of per BC comprises one of the following: per frequency division duplex (FDD) per BC, per time division duplex (TDD) per BC, or per combined FDD-TDD per BC.
